(19) United States
(12) Patent Application Publication
(10) Pub. No.: US 2022/0254549 A1
(43) Pub. Date: Aug. 11, 2022

(54) A COMPOSITE CABLE

(71) Applicant: Molex, LLC, Lisle, IL (US)

(72) Inventor: TAKESHI TSUKAHARA, Yamato (JP)

(73) Assignee: Molex, LLC, Lisle, IL (US)

(21) Appl. No.: 17/611,794

(22) PCT Filed: Jul. 21, 2020
(86) PCT No.: PCT/US2020/042838

§ 371 Date: Nov. 16, 2021

(30) Foreign Application Priority Data
Jul. 29, 2019 (JP) 2019-138437

(51) Int. Cl. H01B 11/20; H01B 11/02; H01B 9/00; H01B 11/18

(52) U.S. Cl. CPC H01B 11/20; H01B 11/1869; H01B 9/003; H01B 11/02

(57) ABSTRACT

A composite cable 1 for data and video signal communication, the composite cable including: an inner layer 11 formed by twisting multiple small diameter electric wires and multiple large diameter electric wires 50 (each having an outer diameter equivalent to the small diameter electric wire or more); and an outer layer 12 formed by twisting multiple coaxial wires 60 (each having an outer diameter equivalent to the large diameter electric wire 50 or more) and one of the large diameter electric wires 50 around the inner layer 1, wherein the coaxial wire 60 and the large diameter electric wire 50 are in close contact within the outer layer 12.

### RELATED APPLICATION

This application claims priority to Japanese Application Serial No. 2019-138437, filed on Jul. 29, 2019, which is incorporated by reference in its entirety.

### TECHNICAL FIELD

The present disclosure relates to a composite cable.

### BACKGROUND ART

Conventionally, in electronic devices such as personal computers, smartphones, tablet terminals, digital cameras, video cameras, music players, gaming devices, and navigation devices, a harness shaped multicore cable is used in which a large number of electric wires are assembled and integrated for connection between a device main body and an external device such as a display. In this case, a planar flat cable may be configured by arranging a large number of electric wires in parallel with both ends connected to an electric connector at a predetermined pitch. However, in order to facilitate handleability, a thick cylindrical cable may be configured by bundling together the electric wires at an intermediate portion in the length direction.

Unfortunately, the thickness of each electric wire differs depending on whether the object to be transmitted is power or a signal, in addition to depending on the type of signal even if the object is the signal. Therefore, a composite cable has been proposed in which, when multiple types of electric wires having different thicknesses are bundled together in an appropriate manner into a cylindrical shape, no useless gaps are generated between the electric wires, making it possible to provide a small cross-sectional area along with easy handleability, in addition to suppressing costs (for example, see Patent Document 1).

FIG. 11 is a cross-sectional view of a conventional composite cable.

In the figure, 801 is a composite cable as a communication cable and is partitioned into a central inner layer 811 and an outer layer 812 around the inner layer 811.

In addition, the inner layer 811 houses six first type electric wire units 851 numbered 1 to 6. Each of the first type electric wire units 851 is a unit having 200 assembled core wires each having a diameter of 0.65 [mm].

Moreover, six second type electric wire units 852 numbered 7 to 12 along with six third type electric wire units 853 numbered 13 to 18 are housed in the outer layer 812. Each of the second type electric wire units 852 is a unit having 200 assembled core wires each having a diameter of 0.40 [mm]. Moreover, each of the third type electric wire units 853 is a unit having 200 assembled core wires each having a diameter of 0.32 [mm].

In this manner, by housing the thickest first type electric wire units 851 in the inner layer 811 and housing the second type electric wire units 852 and the third type electric wire units 853 (which are thinner) in the outer layer 812, the weight of the composite cable 801 is reduced, facilitating transportation and installation.
PATENT DOCUMENT 1: JP 52-149388 A

### SUMMARY

Unfortunately, in conventional composite cables 801, in each of the inner layer 811 and the outer layer 812, there is still a useless gap between the first type electric wire units 851, the second type electric wire units 852, and the third type electric wire units 853 and the cross-sectional area is not sufficiently reduced.

Here, the object of the present invention is to solve the problems of conventional composite cables and provide a composite cable having a very small gap, a small outer diameter, a light weight, easy handleability, low cost, and high reliability.

Therefore, a composite cable is a composite cable for data and video signal communication, the composite cable including: an inner layer formed by twisting multiple large diameter electric wires; and an outer layer formed by twisting multiple coaxial wires (each having an outer diameter equivalent to the large diameter electric wire or more) and one of the large diameter electric wires around the inner layer, wherein the coaxial wire and the large diameter electric wire are in close contact within the outer layer.

Further, in another composite cable, the large diameter electric wire in the outer layer is a ground line.

Further, in yet another composite cable, the coaxial wire is a USB coaxial wire or a video coaxial wire, with the number of the coaxial wires being eight.

Further, in yet another composite cable, the inner layer includes multiple small diameter electric wires each having an outer diameter equivalent to the large diameter electric wire or less, wherein the outer circumferential circle of the inner layer is formed so as to contact the outer circumference of the large diameter electric wire in the inner layer, while the small diameter electric wire is provided in a gap of the large diameter electric wire in the outer circumferential circle.

Further, in yet another composite cable, two large diameter electric wires are provided in the inner layer, eight coaxial wires are provided in the outer layer, and the coaxial wires are arranged such that the angle formed between two tangent lines drawn from the center O of the outer circumferential circle of the inner layer to the circumference of each coaxial wire is 40.132 degrees.

Further, in yet another composite cable, the diameter d of the large diameter electric wire is 1.914-fold the radius r of the coaxial wire.

Further, in yet another composite cable, three large diameter electric wires are provided in the inner layer, eight coaxial wires are provided in the outer layer, and the coaxial wires are arranged such that the angle formed between two tangent lines drawn from the center O of the outer circumferential circle of the inner layer to the circumference of each coaxial wire is 40.380 degrees.

Further, in yet another composite cable, the diameter d of the large diameter electric wire is 1.761-fold the radius r of the coaxial wire.

Further, in yet another composite cable, four large diameter electric wires are provided in the inner layer, eight coaxial wires are provided in the outer layer, and the coaxial wires are arranged such that the angle formed between two tangent lines drawn from the center O of the outer circumferential circle of the inner layer to the circumference of each coaxial wire is 40.742 degrees.

Further, in yet another composite cable, the diameter d of the large diameter electric wire is 1.551-fold the radius r of the coaxial wire.

According to the present disclosure, the composite cable provides a very small internal gap, a small outer diameter, a light weight, and easy handleability. Moreover, it can reduce costs and improve reliability.

### BRIEF DESCRIPTION OF DRAWINGS

FIG. 1 is a cross-sectional view of a composite cable according to Embodiment 1.

FIG. 2 is a cross-sectional view of a composite cable according to a comparative example.

FIGS. 3A and 3B are cross-sectional views describing the densely packed arrangement of the electric wires of the composite cable according to Embodiment 1, wherein FIG. 3A illustrates the state prior to the densification of the arrangement in the outer layer, while FIG. 3B illustrates the state after the densification of the arrangement in the outer layer.

FIG. 4 is a first schematic cross-sectional view describing the relationship between the diameter of the composite cable and the diameter of the ground line according to Embodiment 1.

FIG. 5 is a second schematic cross-sectional view describing the relationship between the diameter of the composite cable and the diameter of the ground line according to Embodiment 1.

FIG. 6 is a third schematic cross-sectional view describing the relationship between the diameter of the composite cable and the diameter of the ground line according to Embodiment 1.

FIG. 7 is a cross-sectional view of a composite cable according to Embodiment 2.

FIG. 8 is a schematic cross-sectional view describing the densely packed arrangement of the electric wires of the composite cable according to Embodiment 2.

FIG. 9 is a cross-sectional view of a composite cable according to Embodiment 3.

FIG. 10 is a schematic cross-sectional view describing the densely packed arrangement of the electric wires of the composite cable according to Embodiment 3.

FIG. 11 is a cross-sectional view of a conventional composite cable.

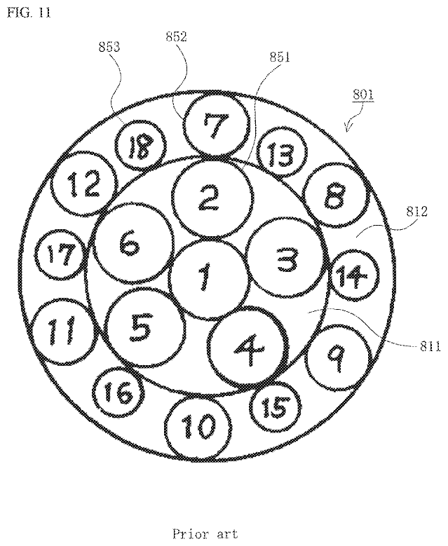

### DETAILED DESCRIPTION OF THE PREFERRED EMBODIMENTS

Embodiments will hereinafter be described in detail with reference to the drawings.

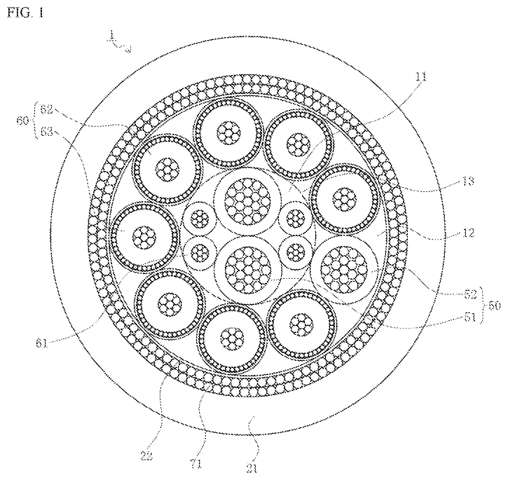

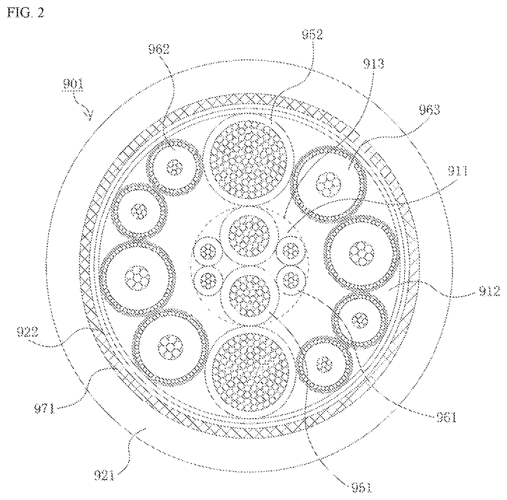

FIG. 1 is a cross-sectional view of a composite cable according to Embodiment 1, while FIG. 2 is a cross-sectional view of a composite cable according to a comparative example.

In FIG. 1, 1 is a composite cable according to the present embodiment, which is used for connecting a device main body and an external device such as a display, in electronic devices such as personal computers, smartphones, tablet terminals, digital cameras, video cameras, music players, gaming devices, and navigation devices, and is suitably used for transmission and reception of various types of data and video signals, as well as for power supply to an external device.

In FIG. 2, the cross section of a composite cable 901 used for connecting a device main body and an external device in a game device, etc. is illustrated. The inside of the composite cable 901 is partitioned into a central inner layer 911 and an outer layer 912 around the inner layer 911, while an outer pressing tape layer 922 is formed by wrapping, for example, resin tape around the outer layer 912. Moreover, an outer shield 971 made of, for example, a metal braid, etc. is provided on the outer circumference of the outer pressing tape layer 922, while an outer coating 921 is provided on the outer circumference of the outer shield 971 as a sheath made of resin, etc.

A pair of twisted power source lines 951 are housed in the inner layer 911. Moreover, multiple signal lines 961 (four in the example illustrated in the figure) signal lines 61 are housed in a gap in the inner layer 911, that is, in the space in which the power source line 951 is not present. Note that the power source line 951 and the signal line 961 each include multiple conductive twisted core wires and an insulating coating covering the periphery of the twisted core wires. Further, an inner pressing tape layer 913 is formed by wrapping resin tape, paper tape, conductive tape, string, etc., for example, around the power source line 951 and the signal line 961 so as to partition the inner layer 911 and the outer layer 912.

Moreover, a pair of ground lines (alternatively, power source lines) 952, multiple (four in the example illustrated in the figure) Universal Serial Bus (USB) coaxial wires 962 for high speed data communication, and multiple (four in the example illustrated in the figure) video coaxial wires 963 for communication of video signals are housed in the outer layer 912. Note that the ground line 952 includes multiple conductive twisted core wires and an insulating coating covering the periphery of the twisted core wires, while the USB coaxial wire 962 and the video coaxial wire 963 each include multiple conductive twisted core wires, a dielectric layer covering the periphery of the twisted core wires, a conductive shielding layer covering the periphery of the dielectric layer, and an insulating coating covering the periphery of the shielding layer. In addition, the ground line 952, the USB coaxial wire 962, and the video coaxial wire 963 are uniformly twisted around the inner layer 911.

Generally, because the USB coaxial wire 962 and the video coaxial wire 963 have different characteristic impedances, giving them different diameters, the diameter of the video coaxial wire 963 is larger than that of the USB coaxial wire 962. In addition, because the upper limit of the resistance value (w/m) of the ground line 952 is often set in accordance with the usage conditions, the optimal diameter and number are generally selected in accordance with the upper limit of the set resistance value. Further, the power source line 951 has an optimal diameter and number, which is selected in accordance with the upper limit of the resistance value set in the same manner as the ground line 952 along with the maximum allowable current. Further, because the signal line 961 is used for low speed data communication, a discrete wire is employed, with a wire having as small a diameter as possible selected.

In the composite cable 901, the optimal combination of each electric wire is determined taking these conditions into consideration. Moreover, an intermediate is inserted into the gap between the electric wires, with the entire composite cable 901 finished so as to be rounded. Further, in order to satisfy the skew characteristics that are one of the electrical requirement characteristics, it is important to uniformly twist the coaxial wires, serving as the coaxial electric wires, in the outer layer 912. At this time, a gap created between the inner layer 911 and the outer layer 912 causes a skew disturbance.

Unfortunately, in the composite cable 901, because there are as many as five electric wires and even the same coaxial wire provides different diameters between the coaxial wire 962 and the video coaxial wire 963, it is difficult to stably twist the electric wires, with skew characteristics unstable. Further, if there are many types of electric wires, the cost of the composite cable 901 itself along with the terminal processing costs of the composite cable 901 increase.

Therefore, in the composite cable 1 according to the present embodiment, as illustrated in FIG. 1, there are as few as two types of electric wires, thereby minimizing the diameter of the composite cable 1. Specifically, the power source line 51 used for power transmission and the ground line 52 are one type of electric wire of the same type with the same diameter, while the USB coaxial wire 62 used for high speed data communication and the video coaxial wire 63 used for video signal communication are one type of coaxial wire of the same type with the same diameter. Note that in the following, in the case of comprehensively describing the power source line 51 and the ground line 52, they are referred to as large diameter electric wires 50, while, in the case of comprehensively describing the USB coaxial wire 62 and the video coaxial wire 63, they are referred to as coaxial wires 60. The large diameter electric wire 50 has an outer diameter equivalent to the signal line 61 or more as a small diameter electric wire used for low speed data communication, while the coaxial wire 60 has an outer diameter equivalent to the large diameter electric wire 50 or more. As a result, in the composite cable 1, the arrangement of the electric wires contained therein can be densified, that is, the densely packed arrangement of the electric wires in the cross section can be achieved, thereby minimizing the diameter.

In the example illustrated in FIG. 1, the inside of the composite cable 1 is partitioned into a central inner layer 11 and an outer layer 12 around the inner layer 11, while an outer pressing tape layer 22 is formed by wrapping, for example, resin tape, paper tape, string, etc. around the outer layer 12. Moreover, an outer shield 71 made of, for example, a metal lateral winding shield, etc. is provided on the outer circumference of the outer pressing tape layer 22, while an outer coating 21 is provided on the outer circumference of the outer shield 71 as a sheath made of resin, etc. Note that the outer shield 71 can be appropriately omitted.

A pair of power source lines 51 which are twisted so as to be in close contact with each other are housed in the inner layer 11. Note that each of the power source lines 51 includes multiple conductive twisted core wires and an insulating coating covering the periphery of the twisted core wires. In addition, an inner pressing tape layer 13 is formed by wrapping resin tape, paper tape, conductive tape, string, etc., for example, around a pair of twisted power source lines 51 so as to partition the inner layer 11 and the outer layer 12. The inner pressing tape layer 13 is formed so as to be in close contact with the outer circumferential surface of the power source line 51, in addition to providing a circular cross section. Therefore, the pair of twisted power source lines 51 are densely arranged within the inner layer 11.

Moreover, multiple (four in the example illustrated in the figure) signal lines 61 may be housed in a gap in the inner layer 11, that is, in the space in which the power source line 51 is not present. Note that each of the signal lines 61 includes multiple conductive twisted core wires and an insulating coating covering the periphery of the twisted core wires. The signal line 61 may be any number or diameter as long as the signal line 61 is housed in the inner pressing tape layer 13 which is formed so as to be in contact with the outer circumferential surface of the power source line 51 and provide a circular cross section.

In addition, as multiple (eight in total in the example illustrated in the figure) coaxial wires, together with one ground line 52, the USB coaxial wire 62 and the video coaxial wire 63 are housed in the outer layer 12. The USB coaxial wire 62 is an electric wire for transmitting and receiving USB signals between a device main body and an external device, for example, two USB coaxial wires 62 are allocated to transmit USB signals from the device main body to the external device, while two USB coaxial wires 62 are allocated to transmit USB signals from the external device to the device main body. Moreover, the video coaxial wire 63 is an electric wire for transmitting and receiving video signals between a device main body and an external device, for example, two video coaxial wires 63 are allocated to transmit video signals from the device main body to the external device, while two video coaxial wires 63 are allocated to transmit video signals from the external device to the device main body.

Note that the ground line 52 includes multiple conductive twisted core wires and an insulating coating covering the periphery of the twisted core wires and is an electric wire having the same diameter in the same type as the power source line 51. The USB coaxial wire 62 and the video coaxial wire 63 each include multiple conductive twisted core wires, a dielectric layer covering the periphery of the twisted core wires, a conductive shielding layer covering the periphery of the dielectric layer, and an insulating coating covering the periphery of the shielding layer. Note that the USB coaxial wire 62 and the video coaxial wire 63 are electric wires having the same type and the same diameter. In addition, the ground line 52, the USB coaxial wire 62, and the video coaxial wire 63 are uniformly twisted around the inner layer 11 so as to be in close contact with each other. The outer pressing tape layer 22 is formed so as to be in close contact with the outer circumferential surface of the ground line 52, the USB coaxial wire 62, and the video coaxial wire 63, in addition to providing a circular cross section. Therefore, the twisted ground line 52, the USB coaxial wire 62, and the video coaxial wire 63 are densely arranged within the outer layer 12. Note that, because the pair of power source lines 51 in the inner layer 11 and the ground line 52 in the outer layer 12 are electric wires having the same type and diameter, as described above, the ground line 52 and one power source line 51 may be arranged in the inner layer 11, while the other power source line 51 may be arranged in the outer layer 12.

Next, a method for densifying the arrangement of electric wires contained within the composite cable 1 having the abovementioned configuration will be described.

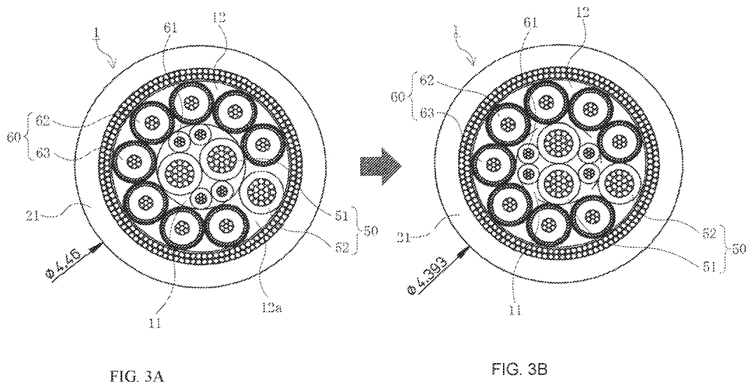

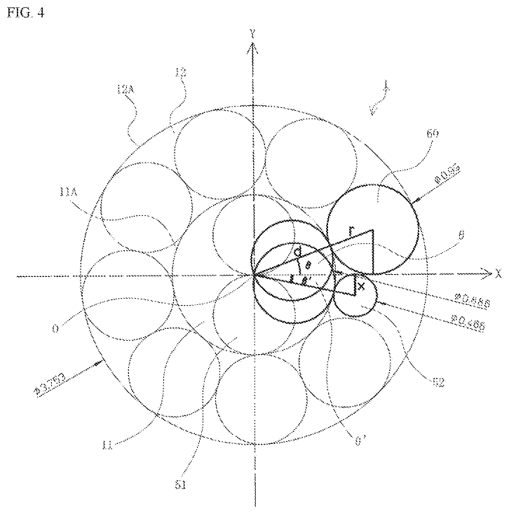

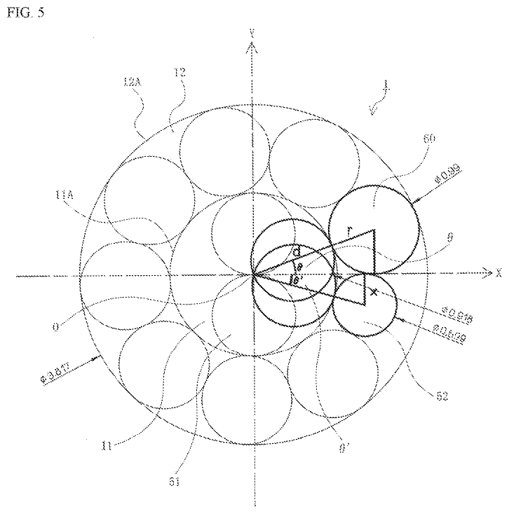

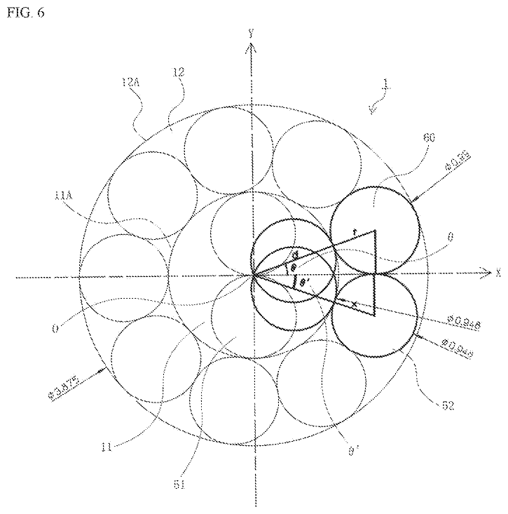

FIGS. 3A and 3B are cross-sectional views describing the densely packed arrangement of the electric wires of the composite cable according to Embodiment 1, FIG. 4 is a first schematic cross-sectional view describing the relationship between the diameter of the composite cable and the diameter of the ground line according to Embodiment 1, FIG. 5 is a second schematic cross-sectional view describing the relationship between the diameter of the composite cable and the diameter of the ground line according to Embodiment 1, and FIG. 6 is a third schematic cross-sectional view describing the relationship between the diameter of the composite cable and the diameter of the ground line according to Embodiment 1. Note that FIG. 3A illustrates the state prior to the densification of the arrangement in the outer layer, while FIG. 3B illustrates the state after the densification of the arrangement in the outer layer.

In the example illustrated in FIG. 3A, the outer circumference of the ground line 52 provided within the outer layer 12 is not in contact with the outer circumference of the coaxial wire 60 on both sides, such that a useless gap 12a is generated between the ground line 52 and the coaxial wires 60 on both sides. Note that, as in the example illustrated in FIG. 1, all of the coaxial wires 60 have the same diameter, while all of the large diameter electric wires 50 have the same diameter.

For example, assuming that the diameter of the coaxial wire 60 is 0.790 [mm] and the diameter of the large diameter electric wire 50 is also 0.790 [mm], the diameter of the composite cable 1 (diameter of the outer surface of the external covering 21) illustrated in FIG. 3A is 4.460 [mm].

Therefore, the diameter of the large diameter electric wire 50, that is, the power source line 51 and the ground line 52, is reduced, thereby eliminating the useless gap 12a. In this manner, when the diameter of the power source line 51 is decreased, the outer diameter of the inner layer 11 housing the pair of twisted power source lines 51 decreases, such that the circumferential length of the outer layer 12 outside the inner layer 11 decreases, while the interval between the electric wires provided in the outer layer 12 must be narrowed. Therefore, as illustrated in FIG. 3B, the outer circumference of the ground line 52 provided within the outer layer 12 contacts the outer circumference of the coaxial wires 60 on both sides, thereby leading to the state in which the useless gap 12a is eliminated.

For example, when the diameter of the coaxial wire 60 is the same as illustrated in FIG. 3A and the diameter of the large diameter electric wire 50 is reduced from 0.790 [mm] to 0.756 [mm], as illustrated in FIG. 3B, the arrangement of the electric wires is densified, thereby leading to the state in which the useless gap 12a in the outer layer 12 is eliminated. The diameter of the composite cable 1 (diameter of the outer surface of the external covering 21) illustrated in FIG. 3B is 4.393 [mm].

In this manner, the outer diameter of the composite cable 1 can be reduced when the arrangement of the electric wires contained therein is densified.

Next, a specific method for arranging the electric wires contained therein will be described.

In FIGS. 4 to 6, the illustration of an outer shield 71, the external covering 21, and a signal line 61 is omitted, while the illustration of the power source line 51, the ground line 52, the USB coaxial wire 62, the video coaxial wire 63, etc. is also simplified and drawn as circles. Note that 11A is the outer circumferential circle of the inner layer 11, while 12A is the outer circumferential circle of the outer layer 12. In addition, two power source lines 51 are densely housed in the inner layer 11 and therefore concentrically arranged so as to be in contact with each other and also in contact with the outer circumferential circle 11A of the inner layer 11. Similarly, eight coaxial wires 60 are also densely housed in the outer layer 12 and therefore concentrically arranged so as to be in contact with each other and also in contact with the outer circumferential circle 11A of the inner layer 11 and the outer circumferential circle 12A of the outer layer 12. O is the center of the outer circumferential circles 11A and 12A, the X axis is the coordinate axis passing through the center O and the boundary between the ground line 52 and the coaxial wire 60 in the cross section of the composite cable 1, and the Y axis is the coordinate axis passing through the center O and orthogonal to the X axis.

In the present embodiment, because the inner pressing tape layer 13 is formed so as to be in close contact with the outer circumferential surface of the pair of twisted power source lines 51 in addition to providing a circular cross section as described above, the outer circumferential circle 11A of the inner layer 11 is equal to the diameter of the power source line 51. Therefore, as illustrated in FIG. 4, if the diameter of the power source line 51 housed in the inner layer 11 is d, the radius of the coaxial wire 60 housed in the outer layer 12 is r, and the angle between the straight line (which connects the center O and the center of the coaxial wire 60 that is outer peripheral to the X-axis) and the X axis is θ, the following formula (1) is satisfied.

sin θ=r/(d+r) Formula (1)

Incidentally, as the ground line 52 housed in the outer layer 12 becomes thinner, the outer diameter of the composite cable 1 decreases. Therefore, in the example illustrated in FIG. 4, the diameter d of the power source line 51 is 0.886 [mm], while the diameter of the ground line 52 is 0.466 [mm]. The diameter of the coaxial wire 60 is 0.990 [mm]. Note that the ground line 52 is arranged such that the outer circumference thereof contacts the power source line 51 of the inner layer 11. In this case, the diameter of the outer circumferential circle 12A of the outer layer 12 is 3.753 [mm].

Therefore, if the radius of the coaxial wire 52 housed in the outer layer 12 is x, and the angle between the straight line (which connects the center O and the center of the ground line 52 that is outer peripheral to the X-axis) and the X axis is θ′, the following Formula (2) is satisfied.

sin θ′=x/(d+x) Formula (2)

Moreover, when the angle between two tangent lines drawn from the center O to the circle of each coaxial wire 60 is 2θ and the angle between two tangent lines drawn from the center O to the circle of the ground line 52 is 2θ′, eight coaxial wires 60 and one ground line 52 which are housed in the outer layer 12 are in contact with each other, thereby satisfying the following Formula (3).

8(2θ)+2θ′=360 degrees Formula (3)

Formula (3) can be modified to obtain the following Formula (4).

2θ=(360−2θ′)/8 Formula (4)

Incidentally, as also described in the example illustrated in FIG. 2, because the upper limit of the resistance value (w/m) of the ground line 52 is often set in accordance with the usage conditions, it is generally desirable to increase the diameter even slightly. Therefore, in the example illustrated in FIG. 4, when the diameter of the ground line 52 is increased from 0.466 [mm] to 0.699 [mm], as illustrated in FIG. 5, the diameter of the outer circumferential circle 12A of the outer layer 12 also increases from 3.753 [mm] to 3.817 [mm]. Note that in the example illustrated in FIG. 5, the diameter d of the power source line 51 arranged in the inner layer 11 also increases from 0.886 [mm] to 0.918 [mm] in order to maintain the state in which all of the electric wires arranged in the outer layer 12 are in contact with each other and also in contact with the outer circumferential circle 11A of the inner layer 11.

Here, the diameter of the ground line 52 is further increased so as to be equal to the diameter of the power source line 51 as in the example illustrated in FIG. 1. Note that, when the diameter of the ground line 52 is further increased, the ground line 52 protrudes from the outer circumferential circle 12A of the outer layer 12, and the outer diameter of the composite cable 1 sharply increases, the diameter of the power source line 51 is considered to be the actual maximum value of the diameter of the ground line 52.

As illustrated in FIG. 6, when the diameter of the ground line 52 is equal to the diameter of the power source line 51, 2x=d. Substituting this into Formula (2) gives the following Formula (5).

sin θ′=x/(2x+x)=1/3 Formula (5)

Note that in the example illustrated in FIG. 6, the diameter of the ground line 52 and the power source line 51 is 0.948 [mm]. In addition, the outer circumferential circle 12A of the outer layer 12 has a diameter of 3.875 [mm].

θ′ satisfying formula (5) is θ′=19.471 degrees. Substituting this into Formula (4) gives the following Formula (6).

θ=20.066 degrees Formula (6)

Substituting this into Formula (1) gives the following Formula (7).

d=1.914r Formula (7)

Formula (6) proves the following. That is, when the coaxial wire 60 is arranged such that the angle between two tangent lines drawn from the center O to the circle of each coaxial wire 60 is 2θ=40.132 degrees, as illustrated in FIG. 6, the diameter of the ground line 52 is equal to the diameter of the power source line 51. In addition, in this case, the relationship between the radius r of the coaxial wire 60 and the diameter d of the power source line 51 is represented by Formula (7).

The composite cable 1 according to the present embodiment includes three types of electric wires consisting of a signal line 61 having a minimum diameter, a large diameter electric wire 50, and the coaxial wire 60. In addition, two large diameter electric wires 50 and multiple (for example, four) signal lines 61, which are twisted so as to be in contact with each other, are housed in the inner layer 11. Note that because one large diameter electric wire 50 included in the inner layer 11 may break, two or more large diameter electric wires 50 are desirably twisted. Moreover, the signal line 61 may be any number or diameter as long as the signal line 61 may be housed in a position (in which no large diameter electric wire 50 is present in the outer circumferential circle 11A of the inner layer 11), that is, a gap.

Moreover, eight coaxial wires 60 and one ground line 52 are housed in the outer layer 12, the diameter of the ground line 52 is equal to the diameter of the power source line 51, the relationship between the radius r of the coaxial wire 60 and the diameter d of the power source line 51 is represented by formula (7), and the eight coaxial wires 60 are arranged such that the angle between two tangent lines drawn from the center O to the circle of each coaxial wire 60 is 40.132 degrees.

As a result, the types of electric wires contained within the composite cable 1 can be reduced to two types, thereby densifying the arrangement thereof. Therefore, the manufacturing cost of the composite cable 1 can be reduced. Moreover, terminal processing of the composite cable 1 can be facilitated so as to reduce processing costs. Further, the coaxial wire 60 can be stably twisted without using an intermediate, thereby improving the skew characteristics.

In this manner, in the present embodiment, the composite cable 1 for data and video signal communication includes: the inner layer 11 formed by twisting multiple signal lines 61 and multiple large diameter electric wires 50 (each having an outer diameter equivalent to the signal line 61 or more); and an outer layer 12 formed by twisting multiple coaxial wires 60 (each having an outer diameter equivalent to the large diameter electric wire 50 or more) and one large diameter electric wire 50 around the inner layer 11, wherein the coaxial wire 60 and the large diameter electric wire 50 are in close contact within the outer layer 12.

As a result, the composite cable 1 provides a very small internal gap, a small outer diameter, a light weight, and easy handleability. Moreover, it can reduce costs and improve reliability.

Moreover, the large diameter electric wire 50 in the outer layer 12 is the ground line 52. Further, the coaxial wire 60 is a USB coaxial wire 62 or a video coaxial wire 63, with the number of the coaxial wires 60 being eight. Further, the outer circumferential circle 11A of the inner layer 11 is formed so as to contact the outer circumference of the large diameter electric wire 50 in the inner layer 11, while the signal line 61 is provided in a gap of the large diameter electric wire 50 in the outer circumferential circle 11A. In this manner, because the types of electric wires contained within the composite cable 1 is reduced, it is possible to easily densify the arrangement of the electric wires and obtain stable skew characteristics.

Further, two large diameter electric wires 50 are provided in the inner layer 11, eight coaxial wires 60 are provided in the outer layer 12, and the coaxial wires 60 are arranged such that the angle between two tangent lines drawn from the center O of the outer circumferential circle 11A of the inner layer 11 to the circumference of each coaxial wire 60 is 40.132 degrees. Further, the diameter d of the large diameter electric wire 50 is 1.914-fold the radius r of the coaxial wire 60. As a result, the densely packed arrangement of the electric wires inside the composite cable 1 can be achieved, thereby minimizing the outer diameter of the composite cable 1.

Next, Embodiment 2 will be described. Note that, for those having the same structure as that of Embodiment 1, descriptions thereof are omitted by giving the same reference numerals thereto. Moreover, descriptions of the same operations and effects as those of Embodiment 1 will be omitted.

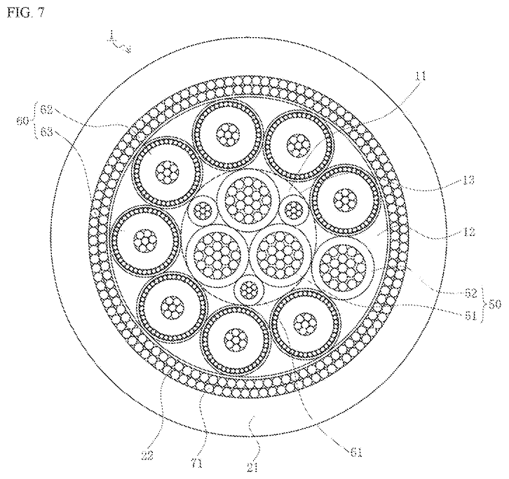

FIG. 7 is a cross-sectional view of a composite cable according to Embodiment 2.

Three power source lines 51 which are twisted so as to be in close contact with each other are housed in the inner layer 11 of the composite cable 1 according to the present embodiment. The inner pressing tape layer 13 is formed by wrapping resin tape, etc., for example, around the three twisted power source lines 51 so as to partition the inner layer 11 and the outer layer 12. The inner pressing tape layer 13 is formed so as to be in close contact with the outer circumferential surface of the power source line 51, in addition to providing a circular cross section. Therefore, the three twisted power source lines 51 are densely arranged within the inner layer 11.

Moreover, multiple (three in the example illustrated in the figure) signal lines 61 are housed in a gap in the inner layer 11, that is, in the space in which the power source line 51 is not present. Note that each of the signal lines 61 includes multiple conductive twisted core wires and an insulating coating covering the periphery of the twisted core wires.

Note that the configuration of the other points of the composite cable 1 according to the present embodiment is the same as that of Embodiment 1, with descriptions thereof omitted.

Next, a method for densifying the arrangement of electric wires contained within the composite cable 1 of the present embodiment will be described.

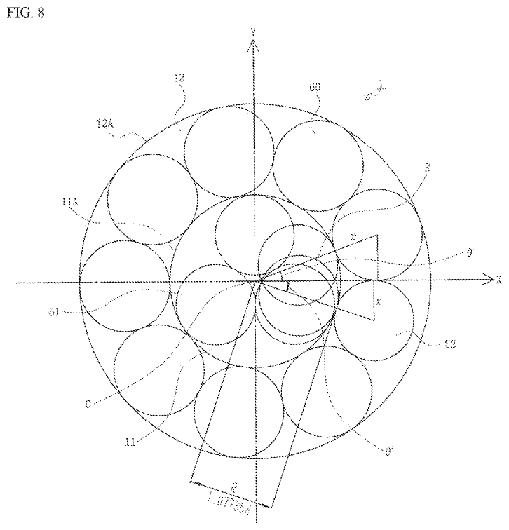

FIG. 8 is a schematic cross-sectional view describing the densely packed arrangement of the electric wires of the composite cable according to Embodiment 2.

In Embodiment 1, because two power source lines 51 housed in the inner layer 11 are in close contact with each other, the radius of the outer circumferential circle 11A of the inner layer 11 is equal to the diameter d of the power source line 51. In contrast, in the present embodiment, because three power source lines 51 are provided, as illustrated in the figure, the center O is disposed outside the outer circumference of the power source line 51, while the radius R of the outer circumferential circle 11A of the inner layer 11 is larger than the diameter d of the power source line 51. Geometrically, when the number of the power source lines 51 housed in the inner layer 11 is n, the radius R is determined by the following formula (8).

R=(1/(2 sin(360 degrees/2×n)+1/2)d Formula (8)

Specifically, the radius R=1.07735d.

Whereupon, Formulas (1) and (2) become the following Formulas (1′) and (2′).

sin θ=r/(1.07735d+r) Formula (1′)

sin θ′=x/(1.07735d+x) Formula (2′)

In addition, formula (5) becomes the following Formula (5′).

sin θ′=0.31698 Formula (5′)

θ′ satisfying Formula (5) is θ′=18.48 degrees. Substituting this into Formula (4) gives the following Formula (6′).

θ=20.19 degrees Formula (6′)

Moreover, Formula (7) becomes the following Formula (7′).

d=1.761r Formula (7′)

Therefore, in the present embodiment, when the coaxial wire 60 is arranged such that the angle between two tangent lines drawn from the center O to the circle of each coaxial wire 60 is 2θ=40.380 degrees, as illustrated in the figure, the diameter of the ground line 52 is equal to the diameter of the power source line 51. In addition, the relationship between the radius r of the coaxial wire 60 and the diameter d of the power source line 51 is represented by Formula (7′).

In this manner, three power source lines 51 which are twisted so as to be in close contact with each other are housed in the inner layer 11 in the composite cable 1 according to the present embodiment, wherein the relationship between the radius r of the coaxial wire 60 and the diameter d of the power source line 51 is represented by Formula (7′). As a result, the types of electric wires contained within the composite cable 1 can be reduced to two types, thereby densifying the arrangement thereof.

Note that the configuration, operation, and effects of the other points of the composite cable 1 according to the present embodiment are the same as that of Embodiment 1, with descriptions thereof omitted.

In this manner, in the present embodiment, three large diameter electric wires 50 are provided in the inner layer 11, eight coaxial wires 60 are provided in the outer layer 12, and the coaxial wires 60 are arranged such that the angle between two tangent lines drawn from the center O of the outer circumferential circle 11A of the inner layer 11 to the circumference of each coaxial wire 60 is 40.380 degrees. The diameter d of the large diameter electric wire 50 is 1.761-fold the radius r of the coaxial wire 60.

As a result, the densely packed arrangement of the electric wires inside the composite cable 1 can be achieved, thereby minimizing the outer diameter of the composite cable 1.

Next, Embodiment 3 will be described. Note that, for those having the same structure as those of Embodiments 1 and 2, descriptions thereof are omitted by giving the same reference numerals thereto. Moreover, descriptions of the same operations and effects as those of Embodiments 1 and 2 will be omitted.

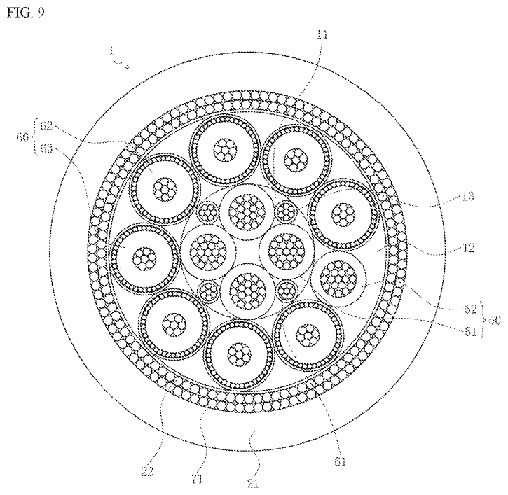

FIG. 9 is a cross-sectional view of a composite cable according to Embodiment 3.

Four power source lines 51 which are twisted so as to be in close contact with each other are housed in the inner layer 11 of the composite cable 1 according to the present embodiment. The inner pressing tape layer 13 is formed by wrapping resin tape, etc., for example, around the four twisted power source lines 51 so as to partition the inner layer 11 and the outer layer 12. The inner pressing tape layer 13 is formed so as to be in close contact with the outer circumferential surface of the power source line 51, in addition to providing a circular cross section. Therefore, the four twisted power source lines 51 are densely arranged within the inner layer 11.

Moreover, multiple (four in the example illustrated in the figure) signal lines 61 are housed in a gap in the inner layer 11, that is, in the space in which the power source line 51 is not present. Note that each of the signal lines 61 includes multiple conductive twisted core wires and an insulating coating covering the periphery of the twisted core wires.

Note that the configuration of the other points of the composite cable 1 according to the present embodiment is the same as those of Embodiments 1 and 2, with descriptions thereof omitted.

Next, a method for densifying the arrangement of electric wires contained within the composite cable 1 of the present embodiment will be described.

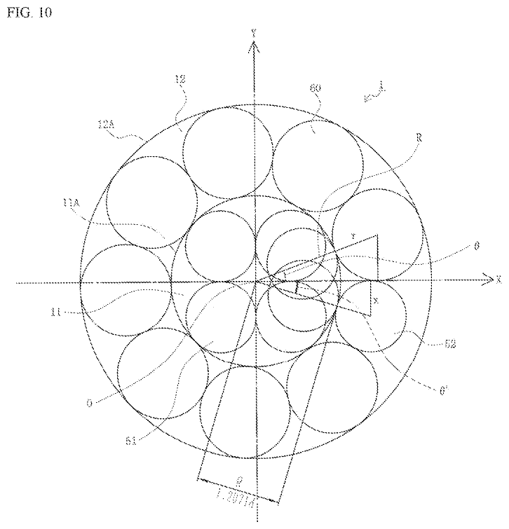

FIG. 10 is a schematic cross-sectional view describing the densely packed arrangement of the electric wires of the composite cable according to Embodiment 3.

In Embodiment 1, because two power source lines 51 housed in the inner layer 11 are in close contact with each other, the radius of the outer circumferential circle 11A of the inner layer 11 is equal to the diameter d of the power source line 51. In contrast, in the present embodiment, because four power source lines 51 are provided, as illustrated in the figure, the center O is disposed outside the outer circumference of the power source line 51, while the radius R of the outer circumferential circle 11A of the inner layer 11 is larger than the diameter d of the power source line 51. Specifically, when determined geometrically, the radius R of the outer circumferential circle 11A of the inner layer 11=1.2071 d.

Whereupon, Formulas (1) and (2) become the following Formulas (1″) and (2″).

sin θ=r/(1.2071d+r) Formula (1″)

sin θ′=x/(1.2071d+x) Formula (2″)

In addition, Formula (5) becomes the following Formula (5″).

sin θ′=0.2928 Formula (5″)

θ′ satisfying Formula (5″) is θ′=17.03 degrees. Substituting this into Formula (4) gives the following Formula (6″).

θ=20.37 degrees Formula (6″)

Moreover, Formula (7) becomes the following Formula (7″).

d=1.551r Formula (7″)

Therefore, in the present embodiment, when the coaxial wire 60 is arranged such that the angle between two tangent lines drawn from the center O to the circle of each coaxial wire 60 is 2θ=40.742 degrees, as illustrated in the figure, the diameter of the ground line 52 becomes equal to the diameter of the power source line 51. In addition, the relationship between the radius r of the coaxial wire 60 and the diameter d of the power source line 51 is represented by Formula (7″).

In this manner, four power source lines 51 which are twisted so as to be in close contact with each other are housed in the inner layer 11 in the composite cable 1 according to the present embodiment, wherein the relationship between the radius r of the coaxial wire 60 and the diameter d of the power source line 51 is represented by formula (7″). As a result, the types of electric wires contained within the composite cable 1 can be reduced to three types, thereby densifying the arrangement thereof.

Note that the configuration, operation, and effects of the other points of the composite cable 1 according to the present embodiment is the same as those of Embodiments 1 and 2, with descriptions thereof omitted.

In this manner, in the present embodiment, four large diameter electric wires 50 are provided in the inner layer 11, eight coaxial wires 60 are provided in the outer layer 12, and the coaxial wires 60 are arranged such that the angle between two tangent lines drawn from the center O of the outer circumferential circle 11A of the inner layer 11 to the circumference of each coaxial wire 60 is 40.742 degrees. The diameter d of the large diameter electric wire 50 is 1.551-fold the radius r of the coaxial wire 60.

As a result, the densely packed arrangement of the electric wires inside the composite cable 1 can be achieved, thereby minimizing the outer diameter of the composite cable 1.

Note that the disclosure herein describes features relating to suitable exemplary embodiments. Various other embodiments, modifications, and variations within the scope and spirit of Scope of the Patent Claims appended hereto will naturally be conceived of by those skilled in the art upon review of the disclosure herein.

1. A composite cable for data and video signal communication, the composite cable, comprising:
an inner layer formed by twisting multiple large diameter electric wires; and
an outer layer formed by twisting multiple coaxial wires (each having an outer diameter equivalent to the large diameter electric wire or more) and one of the large diameter electric wires around the inner layer,
wherein the coaxial wire and the large diameter electric wire are in close contact within the outer layer.

2. The composite cable according to claim 1, wherein the large diameter electric wire in the outer layer is a ground line.

3. The composite cable according to claim 1, wherein the coaxial wire is a USB coaxial wire or a video coaxial wire, with the number of the coaxial wires being eight.

4. The composite cable according to claim 1, wherein the inner layer comprises multiple small diameter electric wires each having an outer diameter equivalent to the large diameter electric wire or less, and
wherein the outer circumferential circle of the inner layer is formed so as to contact the outer circumference of the large diameter electric wire in the inner layer, while the small diameter electric wire is provided in a gap of the large diameter electric wire in the outer circumferential circle.

5. The composite cable according to claim 1, wherein two large diameter electric wires are provided in the inner layer, eight coaxial wires are provided in the outer layer, and the coaxial wires are arranged such that the angle formed between two tangent lines drawn from the center of the outer circumferential circle of the inner layer to the circumference of each coaxial wire is 40.132 degrees.

6. The composite cable according to claim 5, wherein the diameter of the large diameter electric wire is 1.914-fold the radius of the coaxial wire.

7. The composite cable according to claim 1, wherein three large diameter electric wires are provided in the inner layer, eight coaxial wires are provided in the outer layer, and the coaxial wires are arranged such that the angle formed between two tangent lines drawn from the center of the outer circumferential circle of the inner layer to the circumference of each coaxial wire is 40.380 degrees.

8. The composite cable according to claim 7, wherein the diameter of the large diameter electric wire is 1.761-fold the radius of the coaxial wire.

9. The composite cable according to claim 1, wherein four large diameter electric wires are provided in the inner layer, eight coaxial wires are provided in the outer layer, and the coaxial wires are arranged such that the angle formed between two tangent lines drawn from the center of the outer circumferential circle of the inner layer to the circumference of each coaxial wire is 40.742 degrees.

10. The composite cable according to claim 9, wherein the diameter of the large diameter electric wire is 1.551-fold the radius of the coaxial wire.
